(19) United States
(12) Patent Application Publication
(10) Pub. No.: US 2008/0169845 A1
(43) Pub. Date: Jul. 17, 2008

(54) SENSORS USING A PASSIVE S/H AND DDA

(76) Inventor: Weize Xu, Rochester, NY (US)

Correspondence Address: Pamela R. Crocker;Eastman Kodak Company, Patent Legal Staff, 343 State Street, Rochester, NY, 14650-2201, US

(21) Appl. No.: 11/622,777

(22) Filed: Jan. 12, 2007

(51) Int. Cl. G11C 27/02

(52) U.S. Cl. 327/94

(57) ABSTRACT

A CMOS image sensor includes a photosensitive region for collecting charge in response to incident light; a charge-to-voltage mechanism for receiving the charge from the photosensitive region and converting the charge to a voltage; an amplifier for receiving and amplifying the voltage; a sample and hold circuit includes (i) a first capacitor one for receiving the voltage and a second capacitor for receiving a reset level; a first bus for receiving the voltage from the first capacitor and a second bus for receiving the reset level from the second capacitor; a differential difference amplifier for receiving the image voltage and the reset level and for determining a difference level between the image voltage and the reset level and for removing offset of the amplifier; and first and second switches respectively connected to the first and second bus for providing an electrical path for removing charge from each bus.

### FIELD OF THE INVENTION

The invention relates generally to the field of CMOS image sensors, and in particular to such sensors having a differential difference amplifier for buffering, amplification and single-ended to differential signal conversion.

### BACKGROUND OF THE INVENTION

Referring to FIG. 1, there is shown each pixel 10 having the photosensitive region 20 electrically connected to a floating diffusion 30 via a transfer gate (TG) 40 which is selectively pulsed to transfer charge to the floating diffusion (FD) 30. The floating diffusion 30 converts the charge to a voltage which is sensed by an amplifier (M3) 50, preferably a source follower. A reset transistor (RG) 60 resets the signal level on the floating diffusion 30 to a known level. A row select transistor (RS) 70 is pulsed for selecting the particular row for readout to the pixel column bus 75 to a sample and hold circuit 80.

Each sample and hold circuit 80 includes a pair of capacitors 90a and 90b each electrically connected to the pixel column bus 75 respectively via switches 100a and 100b. Each capacitor 90a and 90b is respectively, electrically connected to a buffer amplifier 110a and 100b for storing the charge from the capacitors 90a and 90b and for isolating the signal from the capacitors 90a and 90b from the local bus 120. The buffer amplifiers 110a and 110b are preferably selected for unity gain, but other gains may be desirable based on the pixel array size. The buffer amplifiers 110a and 110b are respectively, electrically connected to the local bus 120 through switches 115a and 115b and eventually to the global bus 130 via switches 140a and 140b that passes the signal to the differential correlated double sampling amplifier 150 (CDS). The CDS 150 typically includes an amplifier, a switched capacitor network and a clock generator circuit (all of which are not shown for simplicity). The sample and hold circuit 80 typically includes a bias transistor (M) 155 for providing current for the amplifier.

Although the prior art is satisfactory, the switched capacitor network inherently includes switching noise and KT/C noise associated with capacitors. The switching between the ON and OFF states also significantly slows down the speed.

### SUMMARY OF THE INVENTION

The present invention is directed to overcoming one or more of the problems set forth above. Briefly summarized, according to one aspect of the present invention, the invention resides in a CMOS image sensor comprising (a) a photosensitive region for collecting charge in response to incident light; (b) a charge-to-voltage mechanism for receiving the charge from the photosensitive region and converting the charge to a voltage; (c) an amplifier for receiving and amplifying the voltage; (d) a sample and hold circuit comprising (i) a first capacitor one for receiving the voltage and a second capacitor for receiving a reset level; (e) a first bus for receiving the voltage from the first capacitor and a second bus for receiving the reset level from the second capacitor; (f) a differential difference amplifier for receiving the image voltage and the reset level and for determining a difference level between the image voltage and the reset level and for removing offset of the amplifier; and (g) first and second switches respectively connected to the first and second bus for providing an electrical path for removing charge from each bus.

The above and other objects of the present invention will become more apparent when taken in conjunction with the following description and drawings wherein identical reference numerals have been used, where possible, to designate identical elements that are common to the figures.

### ADVANTAGEOUS EFFECT OF THE INVENTION

The present invention includes the advantages of high speed, low fixed pattern noise and low temporal noise.

### BRIEF DESCRIPTION OF THE DRAWINGS

FIG. 1 is a schematic diagram of a prior art image sensor;

FIG. 2 is a schematic diagram of an image sensor of the present invention;

FIG. 3 is a detailed schematic of a portion of FIG. 2 illustrating a pixel with its associated sample and hold circuit;

FIG. 4a is a schematic symbol for a single-ended DDA; and

FIG. 4b is a schematic symbol for a differential-ended DDA having a closed loop configuration.

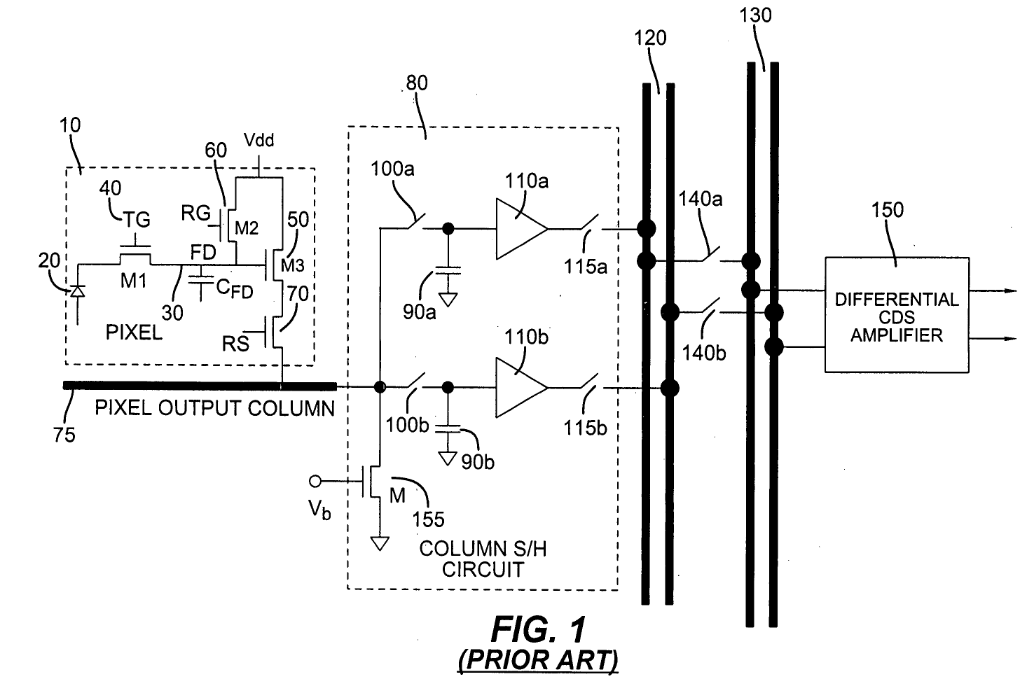

### DETAILED DESCRIPTION OF THE INVENTION

Before discussing the present invention in detail, it is instructive to note that the present invention is preferably used in, but not limited to, an active pixel sensor. Active pixel sensor refers to an active electrical element within the pixel, other than transistors functioning as switches. For example, the floating diffusion or the amplifier are active elements.

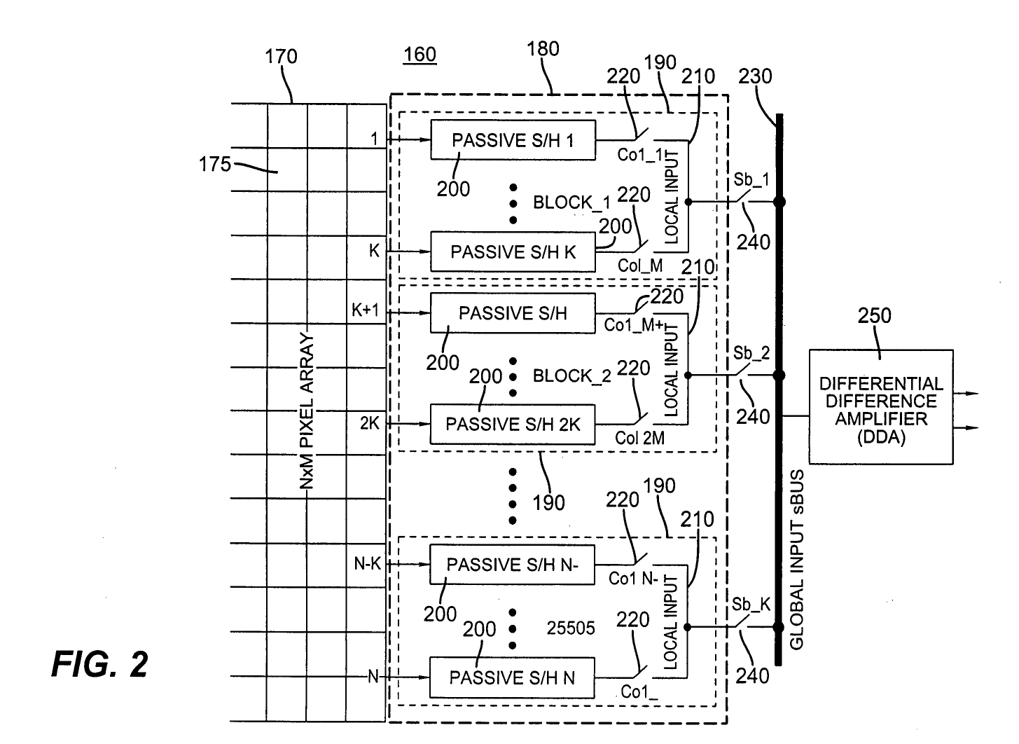

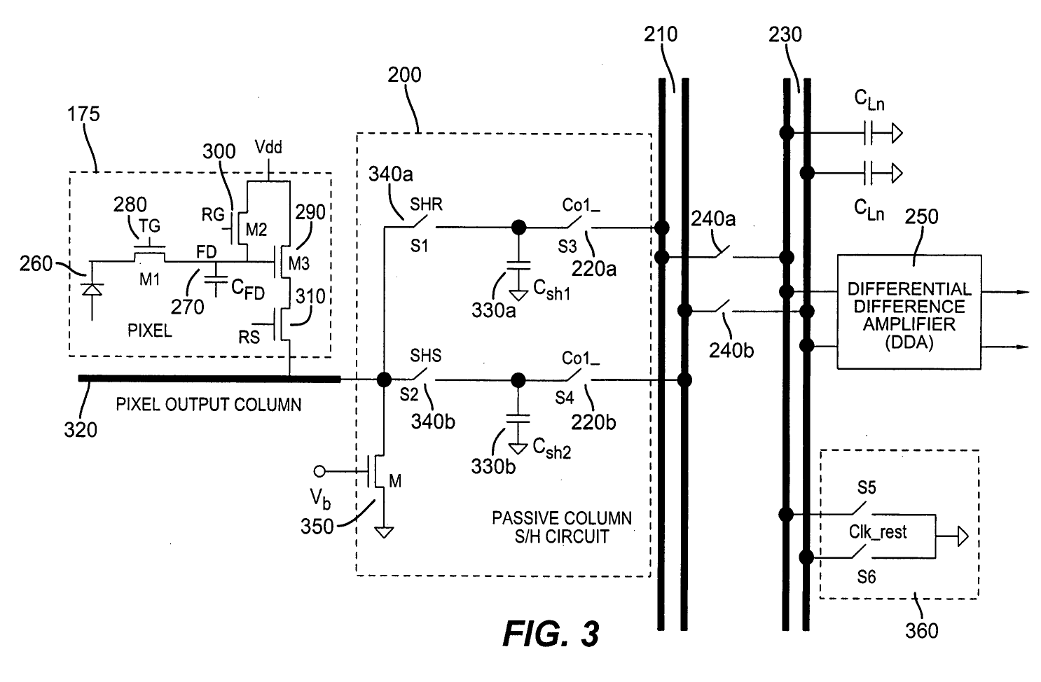

Referring to FIG. 2, there is shown an image sensor 160 having a pixel array 170 which includes a plurality of pixels 175, each pixel includes a photosensitive region (not shown in FIG. 2, shown in FIG. 3) that converts incident light into charge. The pixels 175 are arranged in a two-dimensional array having a plurality of rows and columns. A sample and hold array 180 includes a plurality of subsections of sample and hold arrays 190. Each sample and hold subsection 190 includes a plurality of sample and hold circuits 200 connected to a column of pixels 175 via a pixel output column bus (not shown in FIG. 2, but is shown in FIG. 3). Each sample and hold circuit 200 is connected to a local bus 210 via a switch 220, and each local bus 210 is electrically connected to a global bus 230 via a switch 240. The global bus 230 is electrically connected to the input of a differential difference amplifier (DDA) 250.

Referring to FIG. 3, there is shown each pixel 175 having the photosensitive region 260 (preferably either a photodiode or a pinned photodiode) electrically connected to a floating diffusion (FD) 270 via a transfer gate (TG) 280 which is selectively pulsed to transfer charge to the floating diffusion 270. The floating diffusion 270 converts the charge to a voltage which is sensed by an amplifier (M3) 290, preferably a source follower. A reset transistor (RG) 300 resets the signal level on the floating diffusion 270 to a known level. A row select transistor (RS) 310 is pulsed for selecting the particular row for readout to the pixel column bus 320 to a sample and hold circuit 200.

Each sample and hold circuit 200 includes a pair of capacitors 330a and 330b each electrically connected to the pixel column bus 320 respectively via a pair of switches 340a and 340b. The switch 340a is closed, and the capacitor 330a receives the reset signal level from the reset transistor 300 for resetting the charge level on the capacitor 330a to a known reference level. The switch 340a is opened. Then the reset transistor (RG) 300 is turned OFF and the transfer gate (TG) 280 is turned ON for passing the image signal to the floating diffusion (FD) 270 which is sensed by the amplifier (M3) 290. Switch 340b is closed for passing the image signal from the amplifier 290 to the capacitor 330b. Each capacitor 330a and 330b is electrically connected to the local bus 210 via switches 220a and 220b. When the particular sample and hold circuit 200 is addressed, the two switches 220a and 220b are closed for passing the signal to the DDA 250 (withy switches 240a and 240b closed) via the global bus 230 which includes two distinct lines for respectively passing the charge from the capacitors 330a and 330b. The DDA 250 will amplify the signal and convert the signal to a fully differential signal at the output of the DDA 250. The DDA 250 runs continuously so that it is low noise and high speed since it does not include a lot of switches as in the CDS 150 of the prior art.

The sample and hold circuit 200 includes a bias transistor 350 for providing current for the amplifier 290. A charge clearing circuit 360 is electrically connected to ground for clearing the charge from both the local 210 and global buses 230 before passing charge from the capacitors 330a and 330b so that any residual charge is removed.

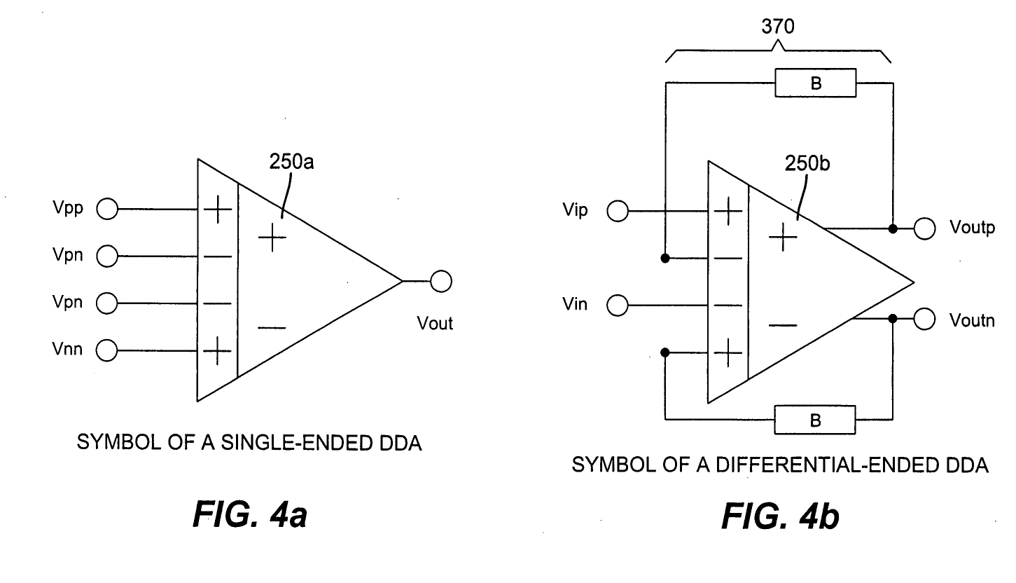

Referring to FIGS. 4a and 4b, there is shown representative symbols for the DDA 250. DDAs 250 are well known in the art, and given the representative symbols, they can be readily produced by those skilled in the art. It is instructive to note that FIG. 4a is single output DDA 250a and FIG. 4b is a differential output DDA 250b. The differential-ended output DDA 250b is preferably used in the present invention; however, it is noted that the single-ended output DDA 250a can also be used. In using the differential DDA 250b in the present invention, a closed loop configuration is preferably used as illustrated in FIG. 4b. The closed loop 370 includes a feedback block for setting the gain (represented by β).

The invention has been described with reference to a preferred embodiment. However, it will be appreciated that variations and modifications can be effected by a person of ordinary skill in the art without departing from the scope of the invention.

### PARTS LIST

10 pixel
20 photodiode/photosensitive region
30 floating diffusion
40 transfer gate
50 amplifier
60 reset transistor
70 row select transistor
75 pixel column bus
80 sample and hold circuit
90a capacitors
90b capacitors
100a switch
100b switch
110a buffer amplifier
110b buffer amplifier
115a switch
115b switch
120 local bus
130 global bus
140a switch
140b switch
150 correlated double sampling amplifier (CDS)
155 bias transistor
160 image sensor
170 pixel array
175 pixel
180 sample and hold array
190 subsection of sample and hold arrays
200 sample and hold circuit
210 local bus
220 switch
220a switch
220b switch
230 global bus
240 switch
240a switch
240b switch
250 differential difference amplifier (DDA)
250a single output DDA
250b differential output DDA
260 photodiode/photosensitive region
270 floating diffusion
280 transfer gate
290 amplifier
300 reset transistor
310 row select transistor
320 pixel column bus
330a capacitor
330b capacitor
340a switch
340b switch
350 bias transistor
360 charge clearing circuit
370 closed-loop (feedback block)

1. An active image sensor comprising;
(a) a photosensitive region for collecting charge in response to incident light;
(b) a charge-to-voltage mechanism for receiving the charge from the photosensitive region and converting the charge to a voltage;
(c) an amplifier for receiving and amplifying the voltage;
(d) a sample and hold circuit comprising:
(i) a first capacitor one for receiving the voltage and a second capacitor for receiving a reset level;
(e) a first bus for receiving the voltage from the first capacitor and a second bus for receiving the reset level from the second capacitor;
(f) a differential difference amplifier for receiving the image voltage and the reset level and for determining a difference level between the image voltage and the reset level and for removing offset of the amplifier; and
(g) first and second switches respectively connected to the first and second bus for providing an electrical path for removing charge from each bus.

2. The active image sensor as in claim 1, wherein the sample and hold circuit is independent of a buffer amplifier.

3. The active image sensor as in claim 1, wherein the sample and hold circuit includes only passive electrical components.

4. The active image sensor as in claim 1, wherein the differential difference amplifier operates continuously.
